(19) United States
(12) Patent Application Publication
(10) Pub. No.: US 2005/0216334 A1
(43) Pub. Date: Sep. 29, 2005

(54) Wireless advertisement system

(76) Inventor: Parviz Mehrabani-Farsi, Austin, TX (US)

Correspondence Address: TROP PRUNER & HU, PC, 8554 KATY FREEWAY, SUITE 100, HOUSTON, TX, 77024, US

(21) Appl. No.: 10/806,632

(22) Filed: Mar. 23, 2004

(51) Int. Cl. G06F 17/60

(52) U.S. Cl. 705/14

(57) ABSTRACT

A system from promoting merchandise through wireless communications. In one embodiment, an interactive voice response system (IVRS) receives a wireless communication from a potential customer (sender). The sender is prompted to specify merchandise of interest. A wireless communication is transmitted to the sender comprising information (e.g., an advertisement) related to the merchandise of interest.

### FIELD OF THE INVENTION

The invention relates generally to business methods and systems and, more particularly, to a method and system that enables a user to obtain, using a mobile communication device, timely information regarding merchandise of interest to the user.

### BACKGROUND

In the present day, the techniques by which individuals obtain information have undergone notable evolution. Not only is there greater reliance on the delivery of information through media other than printed media, but also users have become accustomed to receiving information that is increasingly current.

With specific regard to consumer retail activity, consumers have demonstrated a growing preference to substitute in-store shopping for the convenience of shopping remotely, such as by searches conducted over the Internet. Internet shopping, of course, offers certain advantages, principal among them being the convenience of shopping at home, freedom from crowds, and access to abundant information.

Nonetheless there remains a population, or a segment of the population, that prefers, at least on occasion, to shop at stores, malls and other retail outlets. However, even these dedicated individuals welcome advances in the techniques by which they might better inform their purchases. Roughly concurrent with the growth of information gathering on the Internet, there has appeared a growth in the use of wireless communication devices, such as the cellular telephone, wireless PDAs (personal digital assistants) and the like. However, even though these seemingly ubiquitous appliances possess information-gathering capabilities, techniques for their use in assisting consumer activity have not appeared in significant measure.

### BRIEF DESCRIPTION OF THE DRAWINGS

The subject wireless advertising system may be better understood by, and its many features, advantages and capabilities made apparent to, those skilled in the art with reference to the Drawings that are briefly described immediately below and attached hereto, in the several Figures of which identical reference numerals (if any) refer to identical or similar elements, and wherein:

FIG. 1 is a system diagram of a wireless advertising system in accordance with an embodiment of the invention.

FIG. 2 is a flow diagram of an embodiment of a process by which a user may be navigated through a wireless advertising system in a manner that enables the user to obtain information regarding merchandise that is of interest to the user.

FIG. 3 is a flow diagram of a process by which a retailer may effect self-maintenance of advertising and other information stored on a wireless advertising system.

FIG. 4 is an illustration of a graphical user interface to a website that enables a retailer to effect self-maintenance of advertising and other information stored on a wireless advertising system.

Skilled artisans appreciate that elements in Drawings are illustrated for simplicity and clarity and have not (unless so stated in the Description) necessarily been drawn to scale. For example, the dimensions of some elements in the Drawings may be exaggerated relative to other elements to promote and improve understanding of embodiments of the invention.

### DETAILED DESCRIPTION

For a thorough understanding of the subject wireless advertising system, reference may be had to the following Detailed Description, including the appended Claims, in connection with the above-described Drawings.

In one embodiment, there is provided a business method and an implementing system for delivering an advertisement service that will provide targeted advertisements to the public, utilizing wireless and other mobile communication techniques. By using existing mobile communication technology, a retailer is able to subscribe to the advertisement service and to have delivered specific advertisements and other information, such as coupons, to customers who may be interested in favorable promotional offers occurring at retail stores. The retailers are provided the ability to self-maintain and update the content of their respective advertisements at any time via email, the worldwide web (www), or via a phone call.

The service is a complete speech/voice-driven advertisement service. A targeted customer may use his mobile phone to call a toll-free number and request various information regarding merchandise of interest to the customer, including specials occurring with respect to specific merchandise. In one embodiment, information may be restricted within the requested locale. Locality may be confined to a city metropolitan area by the system, based on the telephone number of the caller/customer. The specification of locality may be modified or further refined by the customer, perhaps to a smaller area identified by a mall or a shopping center area or, in the limit, to a particular store. As a customer request is submitted to the system, the customer will hear a related advertisement that is responsive to his request. Advertisements are organized in a top-down fashion from mall entity, to stores contained within that mall, to category, section, and to a general term used to identify a specific item. As each item is found that matches the consumer's request, an advertisement, if set at the respective level, is heard by the consumer. Each advertisement can be associated with a coupon or additional information that relates to the merchandise, which may be delivered to the consumer in either text or graphics format. The consumer can request that the coupon be transmitted instantly to his/her mobile phone.

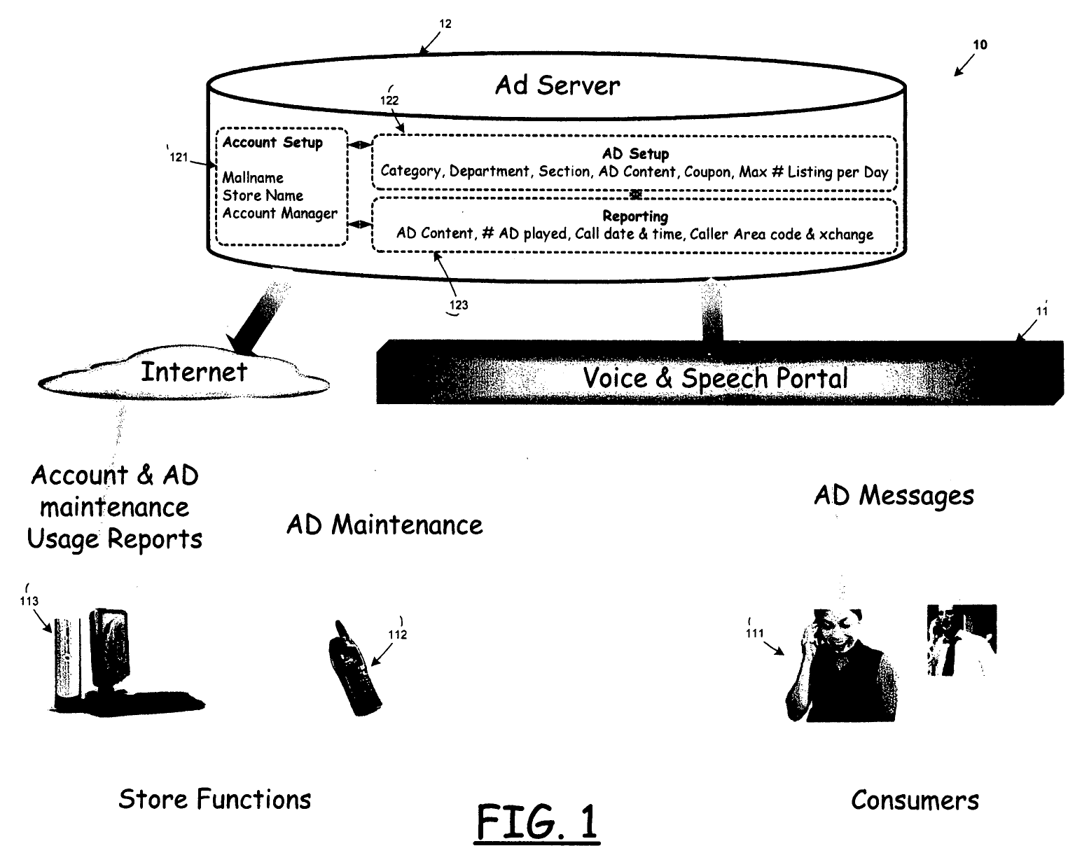

FIG. 1 is a representation of a system that may be used to implement an interface with both retailers and potential customers of those retailers. Referring now to FIG. 1, in one embodiment a representative system 10 comprises a voice and speech portal 11 that enables bi-directional voice communication between the system and both retailers and potential consumers. In one configuration, portal 11 includes, in essence, an interactive voice response (IVR) system that accepts telephone calls from both potential customers 111 and from retailers 112.

In general, both customers and retailers may access portal 11 through either a wireline communications device or through a wireless device, such as a cellular telephone, for example. Customers are enabled to receive, either upon request or spontaneously, information regarding merchandise of interest to the customer. In a manner that will be described in detail below, portal 11 has the capability to navigate both experienced and noviate users through a sequence of queries and responses that satisfy the user's request for information related to merchandise of interest.

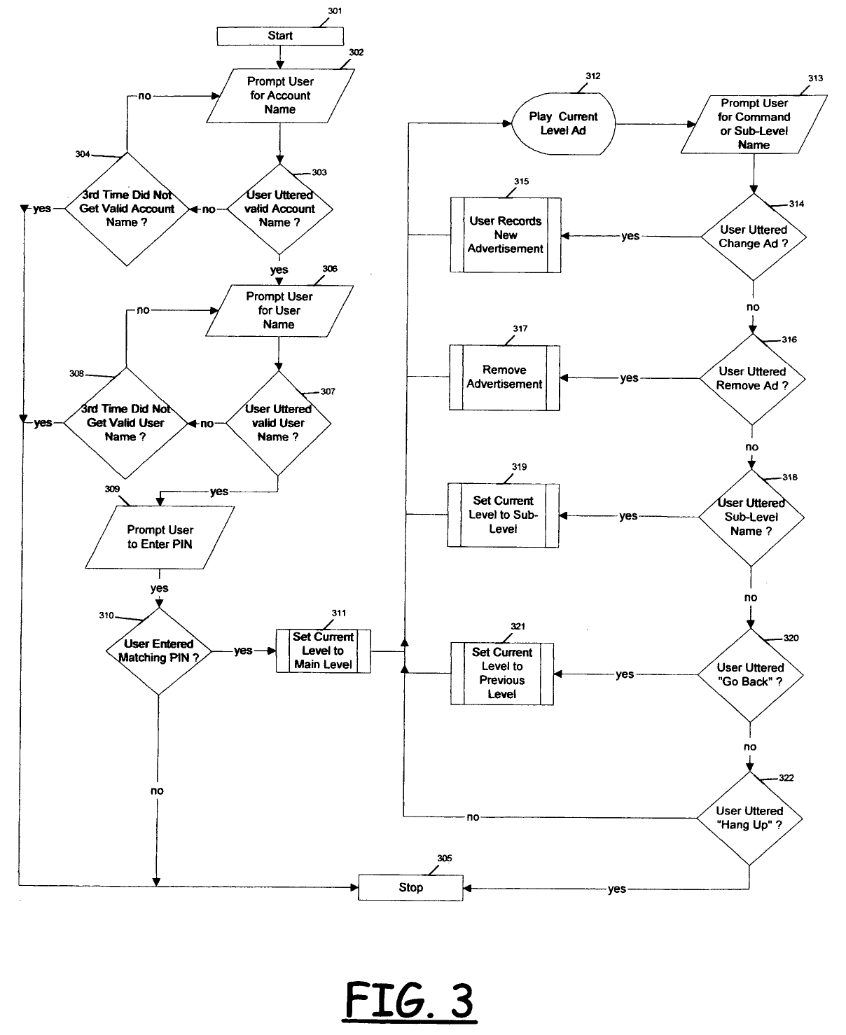

In addition, portal 11 is accessible by retailers 112 so that retailers are enabled to provision and maintain on system 10 advertisements and other information that is related to merchandise marketed by the retailers. For example, retailers may secure access to the system through either a wireline or wireless communication device and, having obtained access, may dictate advertisements, initiate and determine the duration of special offers, create coupons for merchandise, and the like. A specific embodiment of a process by which retailers may perform such self-maintenance of advertisements is described below and depicted in FIG. 3.

In addition, and as depicted in FIG. 1, retailers may actuate certain store functions through access acquired over a public data communications network. In particular, retailers, or their authorized employees or agents, may operate personal computers 113 to obtain access, through the Internet, for example, to a server system 12. Server 12 may sometimes be referred to herein as a “store server” or an “ad server”. Although the retailer may obtain access to system 10 through the Internet, it is contemplated that alternative forms of access, e.g., other communications networks, may also be enabled. By virtue of access to the server 12, retailers may receive information, such as ad usage reports, and may perform account and advertisement-maintenance functions. As indicated in FIG. 1, ad server 12 incorporates a number of component functions, including an account setup function 121, an AD setup function 122, and a reporting function 123.

In one embodiment, an account setup function operates to define individual accounts by mall name, store name, and account manager. In addition, account setup function 121 may perform a gatekeeping function by enforcing passcode or PIN (personal identification number) requirements as a condition for accessing AD setup function 122 and/or reporting function 123.

AD setup function 122 organizes and maintains advertisements for individual retailer accounts and contains fields identified by category, department, section, AD content, coupon, Max Number per Day, and similar designations.

Reporting function 123 is coupled to both account setup function 121 and to AD setup function 122 and has the capability to report desired information to retailers, including, for example, AD content, the number of ads played, data and time of calls (associated with ads played), and the caller area code and exchange.

In one embodiment, the consumer interface to system 10 is implemented as a speech-recognition system that may primarily be accessed by using a phone. The interaction by a consumer and system 10 starts by the consumer dialing a toll-free number or a quick-dial number of the mobile phone carrier. Once connected to system 10, the consumer is prompted to specify items of interest for possible purchase. The Consumer may form his request by specifying a general category or by being more specific. For example, in one embodiment the consumer may mention category, along with section and generic term for the item. For example, the consumer may say “men's apparel” or “shoes”. Alternatively, the consumer may become increasingly specific and say “men's waterproof shoes”.

If the consumer is unfamiliar or inexperienced with system and experiences difficulty in conveying his request, he/she is directed into a more menu-driven portion of system. Here the consumer is specifically asked to specify a category of item, and then section, and finally the item itself. At each level, all available options are also provided to the consumer so that the consumer may select from available choices. As a first-time user/consumer completes his request, he will hear a voice prompt training him how to extract information he is interested in more rapidly in future interactions.

Once an item is identified by the consumer, the system then prompts the consumer to specify a mall or/and a store where he desires to shop. Consumers also have option to search an entire city (as defined by data) for their request. Once a request is submitted for final submission to the search engine that is associated with the ad server, the consumer will hear advertisements related to his search. At the point when each advertisement has been played, the consumer will also have the option to receive a coupon or additional graphics data associated with each ad, to the extent the retailer has so provided.

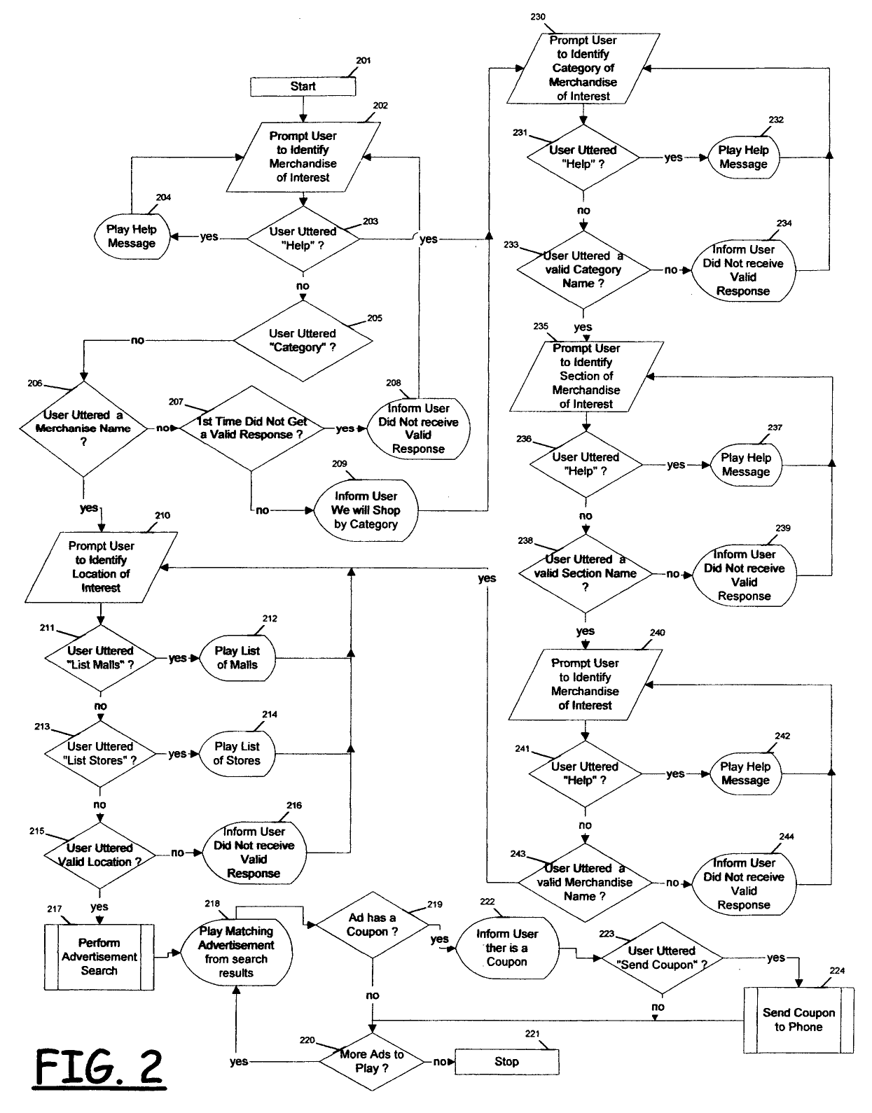

FIG. 2 is a flow diagram that illustrates, in one embodiment, the manner in which a potential customer interacts with the system. In this aspect, customer interaction is confined principally to interaction with the IVR system 11 through the customer's wireless device.

Referring now to FIG. 2, depicted there is a flow diagram that illustrates an embodiment of a process whereby a user (i.e., a potential customer of merchandise) may be navigated through the operation of IVR system 11 to obtain information regarding merchandise of interest to the user.

An arbitrary starting point is indicated at 201. Subsequently, at 202 the user is prompted by the IVR system to identify merchandise of interest to the user. If at 203 the user requests help, then at 204 a “Help” message is conveyed to the user. In one embodiment, the “Help” message may be transmitted from the IVR system to the user's wireless device, e.g. cellular telephone. After the “Help” message is transmitted, the process returns to 202.

In the event that at 203 the user had not requested help, at 205 a determination is made whether the user had articulated “Category,” indicating the user's intent to receive information regarding a particular category of merchandise.

If at 205 the user had not responded to the system prompt with “category,” then at 206 a determination is made whether the user had responded with a merchandise name. If not, then at 207 a determination is made whether the failure was the first instance upon which the user failed to provide the IVR system with a valid response. If so, then at 208 the user is notified that the system has not received a valid response, and the process returns to 202. If, however, at 207 a determination is made that there has occurred (at least) a second invalid response from the user, then at 209 the user is informed that shopping will proceed by category. Subsequently, the process branches to steps 230 et seq., described below.

If, however, at 206 the user had responded with a name of merchandise of interest, then at 210 the IVR system prompts the user to identify a location of interest. In one embodiment, a location may be a mall location or a store location, for example. At 211 at determination is made whether the user articulated “list malls”. If so, at 212 a list of malls is transmitted to the user, and the process returns to 210. If however, at 211 the user had not requested a list of malls, then at 213 a determination is made whether the user had requested from the IVR system a list of stores. If so, then at 214 a list of stores is transmitted to the user, and the process returns to 210. If, at 213 the user had not requested an enumeration of stores, then at 215 a determination is made whether the user had, at this point, provided the IVR system with a valid location. If not, at 216 the user is so informed, and the process flow returns to 210.

If, however, at 215 the user had provided the IVR system with a meaningful location to contemplate a purchase transaction, then at 217 an advertisement search is conducted. Specifically, at 217 a query is lodged at the ad server, depicted in FIG. 1, to determine whether, at the location of interest to the user, there is operative an advertisement associated with the merchandise of interest to the user. At 218, any advertisement resulting from the search conducted at 217 is transmitted to the user. The nature of the advertisements played is not restricted and may assume any form of communication that is accessible to the user. In one embodiment, the user may engage the IVR system through a wireless device. Accordingly, depending on the capabilities of the wireless device in possession of the user, compatible forms of advertising information may be conveyed, and the information may be conveyed through access to any of a number of compatible media. In accordance with one embodiment, the user may access the system through a wireless device, such as a cellular telephone, and advertising information may be conveyed as an audio announcement, or a textual message or graphical or video image on the user's telephone.

Subsequent to conveyance of an advertisement, in whatever form, a determination is made at 219 whether there is a coupon associated with the advertisement. In one embodiment, the existence, vel non, of an appropriate coupon may have been returned with the results of the search performed at 217. If there are no associated coupons, then at 220 a determination is made whether there are more advertisements to be “played.” If so, process flow returns to 218. If not, then at 221 the session is effectively terminated. However, if at 219, it is determined that there exists in the system an advertisement associated with the immediately preceding advertisement, then at 222 the user is provided a message to this effect. If at 223 the user articulated a desire to receive the coupon, then at 224 a coupon is transmitted to the user's cellular telephone. In one embodiment the coupon may assume the form of a text message. The text message may impose terms and conditions, as established, for example, by a retail entity, on the user's rights under the coupon. After the coupon has been transmitted, or in the event the user did not request a coupon, the process flow returns to 220 to determine whether additional applicable advertisements are available to the user.

Recall that, as indicated above, in the performance of step 207 it may be determined that a user has repeatedly (at least twice) provided the system with an invalid response. If so, then at 209 the user is informed that shopping will, at this point, proceed according to category. Process flow is diverted to 230, where the user is prompted to identify a category of merchandise of interest. If in response to the prompt, the user at 231 requests help, then at 232 an appropriate help message is transmitted to the user. In one embodiment, the contest of the help message may comprise a message directing the user to select a category either by speaking a category name or by selecting from a list of commands made available to the user at this point. Typical commands may include “Go Back”, “Main Menu”, “List Categories”, etc. Subsequent to the help message, the user is again prompted at 230. If, however, the user did not at 231 request help, then a determination is made at 233 whether the user articulated a valid category of merchandise. If not, at 234 the user is so informed, and the process returns to 230.

However, if at 233 the user did not respond with a valid category name, at 235 the user is prompted to respond with a section of merchandise of interest. A “section” may be a subgroup of merchandise within a category. For example, the category “Men's Apparel” may comprise the sections “Outerwear”, “Shirts”, “Shoes”, “Underwear”, etc. If at 236 the user responds to the prompt with a request for help, then at 237 a help message is provided to the user and the process returns to 235.

If, however, the user did articulate a valid section name at 238, then at 240 the user is prompted to identify merchandise of interest. If in response to this most recent prompt the user requests help at 241, then a help message is transmitted at 242, and the process returns to 240. At 243 at determination is made whether the user articulated a valid merchandise name in response to the prompt issued at 240. If not, at 244 the user receives a message informing him that a valid response has not been received. The process flow then returns to 240. If, however, the user has articulated a valid merchandise name, then the process reconvenes the sequence at step 210.

In accordance with an embodiment of the invention, the system responds to a customer request in conformance with a defined algorithm. In one embodiment, the algorithm may progress as follows:

Once a request from consumer is received, the system will search for the requested item within the defined locale by consumer. One of following scenarios will necessarily occur:

If a predetermined correct number of entries matching the request are found, the system may, in an embodiment, play the associated advertisements in the order of entity's membership level in this service, or in the order of value the advertisement provides to consumer. Alternatively, the advertisement may be played randomly, that is, in no particular predetermined order. If played according to membership level, an advertisement for an item will be played first if it belongs to a mall and a store with higher membership level. In this regard, a membership level may be assigned to a retailer according to a number of criteria, such as an assessment of the value of the retailer's participation. Membership level may relate, for example, to the size of the retailer's presence in the relevant market or to amount that the retailer spends in advertising on the system. An assignment of membership level may result from a negotiation with the retailer.

If an excessive number of matches are found for a given request, the customer is given an option to narrow the possibilities in the following order:
1. If the consumer did not identify a category and the searched results contain more than one category, the consumer is given the choice to select from the found categories.
2. If the consumer did not identify a section and searched results contain more than one section, the consumer is given the choice from the found sections.
3. If the consumer did not specify either a mall or store:
   a) and searched results contain more found stores than malls, then the consumer is given the choice to select from found stores; or
   b) the searched results contain more found malls, the consumer is given the choice to select from found malls.
4. If the consumer specified a store but not a specific mall, then the consumer is given the choice to select from found malls.
5. If the consumer specified a mall but not a specific store, then the consumer is given the choice to select from found stores within that mall.

If no matches are found for a given request, the system will expand the search according to following and offer the consumer to obtain these alternate choices:
1. If the consumer did not specify either a mall or a store, the consumer is informed that the system did not find any specials matching their request.
2. If the consumer specified a store, the system will expand the search to any store within the mall (as defined by data).
   a) If the expanded search does not produce any matches, the system will then expand search to any mall within a city.
      i. If the search does not produce any matches, the consumer is informed that system did not find any specials matching his request.
      ii. Consumer is informed that matches where found at another location. The consumer is queried whether there is an interest in listening to alternatives.
   b) The consumer is informed that matches where found at another store within same mall and is queried whether there is an interest in listing to alternatives.
3. If the consumer specified a mall, the system will expand the search to any mall within a city (as defined by data).
   a) If the expanded search does not produce any matches, the consumer is informed that system did not find any specials matching their request.
   b) The consumer is informed that matches where found at another location and is queried whether there is an interest in listening to alternatives.

As a further capability (in addition to the consumer-request capabilities described above), there is provided in one embodiment a robust set of capabilities intended to render the system more attractive to retailers. Specifically, a salient aspect of the interface is the retailer provision of the capability of retailers to individually maintain their own advertisements, without intercession from the system proprietor or from third parties.

Once an account is setup within the system, retailers are afforded capability to add or update content of their advertisements and coupons. Ad maintenance may be inducted from the internet via a web page or by sending an email. In addition, ad maintenance, may occur via voice by calling a number. Updates will take effect substantially instantaneously.

In order to enable an advertiser to entice consumers to the advertiser's location during “slow” days/hours, retailers/advertisers will have the option to schedule advertisements in advance of time when the advertisements are to be effective. That is, when pacing ads they can specify time frames (hour ranges) the ads are to be played.

An advertiser may be assessed a preset fee per advertisement or coupon sent to consumer based on length of advertisement. In order to facilitate maintaining advertisement budgets for each entity, the retailer has option to set a preset limit on number of ads played per data per type as well as an overall preset limit on total spending per day. For example, an advertiser can specify to only play an advertisement for a section up to 100 times per day or only send coupons to mobile phones up to 50 times a day while limiting total spending to a predetermined amount per day.

Retailers will have real-time access to their account activity via Internet, for example. They will have access to information such as number of each Ads played, Call date and time, Area code and exchange of the Caller.

Further enhancements of this service will add ability to track consumer's use of the system. Once a consumer has passed a certain threshold of use (becomes a regular user), the system will prompt the user to establish a profile on a system. The profile will offer the consumer benefits, such as receiving notifications via email or as a message on their mobile phone when a special occurs in an area of their interest and that matches the consumer's profile. The consumer will also have the option to restrict when these notifications can be sent.

As the availability of location information of mobile phones becomes more widespread in the domestic market, potential consumers who have established a profile will automatically receive advertisement on their phones that match and conform to the consumer's profiles, without having to initiate calls to this service. One attribute of when data is sent to consumer is a range specified by the retailer (from three feet to many miles). That is transmission of advertisements to a consumer may occur only when the consumer is detected within a specified boundary.

Referring now to FIG. 3, depicted there is a flow diagram that represents a process sequence according to which, in one embodiment, a retailer is enabled to perform maintenance of the retailer's advertisement via an IVR system, such as, for example, the IVR system depicted in FIG. 1.

As represented in FIG. 3, the ad maintenance process begins at 301. At 302 a retailer who has accessed the IVR system by, either a wireline or wireless connection, is prompted to provide an account name. at 303, the system determines whether the retailer has responded with a valid account name. If the retailer had not responded with a valid account name, then at 304 the system determines whether the present instance is the third, for example, instance (in the session) on which the retailer failed to respond with a valid account name if it was not, then the process returns to 302. if it was, the process is terminated at 305.

If at 303 the retailer has responded with a valid account name, then at 306 the system prompts the retailer to provide a user name. At 307 the system determines whether the retailer has responded with a valid user name. If not, then at 308 the system determines whether this in the third instance in then-current session that the retailer failed to provide a valid user name. If not, then the process returns to 306. If so, then the process is terminated at 305.

If at 307 the retailer had responded with a valid user name, then at 309 the system prompts the user to enter a PIN (personal identification number). At 310, the system determines whether the PIN provided matches the account name and/or the user name previously provided in the session. If not, the process terminates at 305. If so, then the current ad level is set to the main level.

In one embodiment, there may exist a maximum number (four, for example) of advertisement levels that pertain to merchandise. In decreasing hierarchical order, the ad levels may be, for example: Store, Category, Section, and Item. So, a store may comprise many categories, and an ad at the store level applies to all sublevel categories in the store. A category may comprise many sections, and an ad at the category level applies to all sublevel sections in the category.

At 312, the system provides the retailer with an audibly discernible rendition of the current ad level, and at 313, prompts the user for a command or sublevel identification. At 314 the system determines whether the retailer has responded with a request for an ad change. If so, at 315 the user is enabled to record a new ad on the IVR system and the process flow returns to 312. if at 314 the retailer had not requested an ad change, then at 316 the system determines whether the user has requested the current add to be removed. If so, at 317 the current ad is removed. If at 316 the retailer had not requested removal of an ad, then at 318 the system determines whether the user had responded with a sub-level identification. If so, then at 319, the current ad level is set to the user-specified sub-level, and the process flow returns to 312. if at 318 the user had not responded with a sub-level name, then at 320 the system determines whether the user had uttered the phrase “Go Back,” or an equivalent phrase. If so, then at 321, the system set the current ad level to the immediately previous ad level, and the process flow returns to 312. If at 320 the user had not uttered “Go Back,” then at 322 the system determines whether the user has spoken the phrase “Hang Up,” or an equivalent phrase. If so the process terminates at 305. If not, the process flow returns to 312.

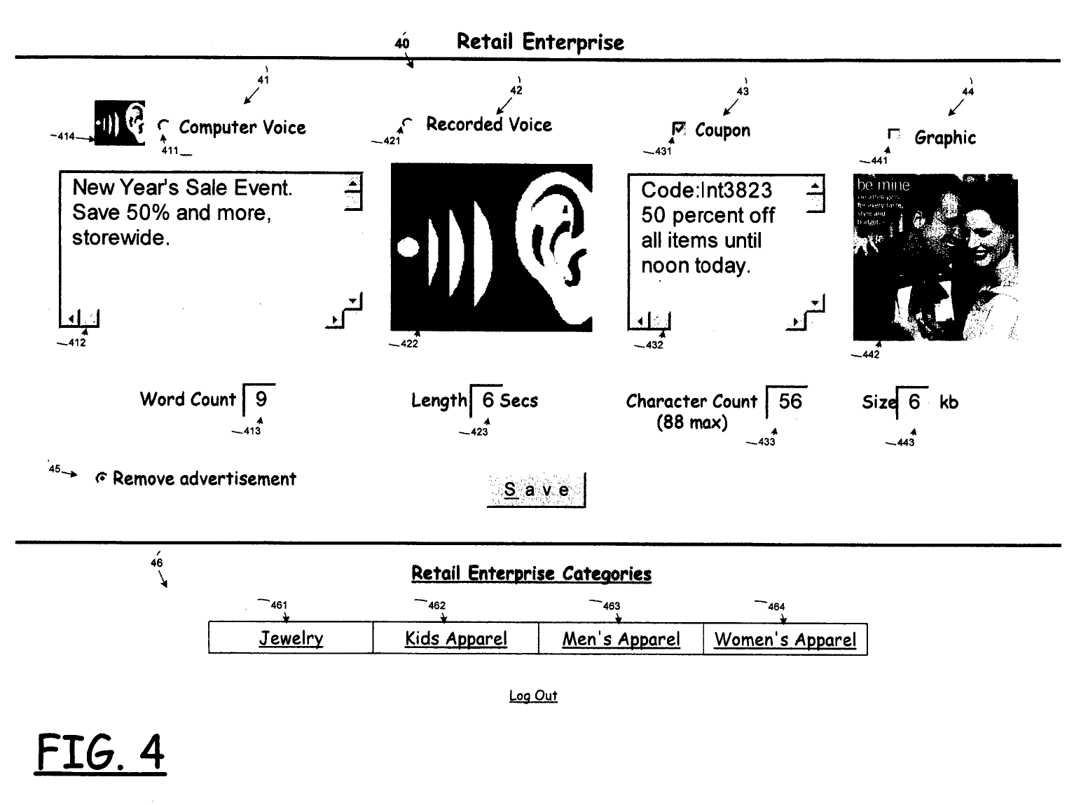

FIG. 4 represents an embodiment of a graphical user interface 40 (GUI) to a website that may be used by retailers to perform self-maintenance of the retailer's information on system 10. Advertisement self-maintenance via GUI 40 may be deemed either an alternative or complement to self-maintenance through portal 11, as has been described above. GUI 40, and is associated website, may be maintained on ad server 12, or may reside on a separate server system (not shown) that has access to, and is accessible by, server 12.

GUI 40 present a collection of windows 41, 42, 43 and 44 that enable the retailer to review various types of information related to the retailer's merchandise, as that information is stored on ad server 12, for example. Window 41 is directed to advertisements that are disseminated in a computer-simulated voice format. Window 41 may be activated via a selection node 411. When selection node 411 is activated, the retailer is provide with a computer voice simulation of advertising text. Area 412 associated with window 41 presents to the retailers a textual rendition of a then-existing advertisement. Area 413 provides an indication of the word count that constitutes the respective advertisement.

Window 42 is directed to advertisements that are disseminated in a real-voice format. Real-voice advertisements may be written to ad server 12 through a telephone (mobile or landline) call made by a retailer. In alternative embodiments, other mechanisms may be utilized to write advertisements to ad server 12. When activated via selection node 421, window 42 replays the recorded real-voice ad content. Area 423 provides an indication of the time duration to the advertisement represented by window 42.

Window 43 is dedicated to coupons made available by the retailer. The text of the coupon appears in area 432, and the respective word-count in area 433. Selection window 431 activates the coupon.

Window 44 is dedicated to a graphical advertisement that may be disseminated to a user's picture phone, for example. The graphical advertiseing image appears in areas 442, and a selection window is provided at 441. A window 443 contains a data count of the image in window 442.

In addition, GUI 40 comprises an area 46 wherein there are included a number of links, 461, 462, 463 and 464, for example, to categories of merchandise that are available from the respective retailer. When activated, each of links 461, 462, 463, 464 causes the ad level to be transformed to the sublevel indicated by the link. In one embodiment, the page format is preserved, and the page is populated with the data applicable to the given level. However, the attributes of that level may be modified.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method of promoting merchandise, the method comprising:
receiving a communication from a sender;
prompting the sender to specify merchandise of interest to the sender; and
transmitting a communication to the sender, wherein the wireless communication comprises an advertisement that is related to the merchandise of interest.

2. A method as defined in claim 1, wherein the advertisement comprises a message to be received by a wireless communication device.

3. A method as defined in claim 2, wherein the message comprises audible information.

4. A method as defined in claim 2, wherein the message comprises graphical information.

5. A method as defined in claim 2, wherein the message comprises video information.

6. A method as defined in claim 2, further comprising:
transmitting a coupon to the sender, wherein the coupon is related to the merchandise of interest.

7. A method as defined in claim 6, wherein the coupon comprises a text message to be received by the wireless communication device.

8. A method as defined in claim 6, wherein the coupon comprises graphical information to be received by the wireless communication device.

9. A method as defined in claim 7, wherein the coupon is transmitted at the option of the sender.

10. A method as defined in claim 1, wherein prompting comprises:
transmitting a wireless communication to the sender, the wireless communication comprising an audibly discernable list of shopping centers; and
receiving a selection of a shopping center from the sender.

11. A method as defined in claim 10, further comprising:
transmitting to the sender an advertisement applicable to a shopping center selected by the sender.

12. A method as defined in claim 10, further comprising:
transmitting to the sender an audibly discernible list of stores in a shopping center selected by the sender; and
receiving a store selection from the sender.

13. A method as defined in claim 12, further comprising:
transmitting to the sender an advertisement applicable to a store selected by the sender.

14. A method as defined in claim 12, further comprising:
transmitting to the sender an audibly discernible list of merchandise in a store selected by the sender; and
receiving a merchandise selection from the sender.

15. A method as defined in claim 14, further comprising:
transmitting to the sender an advertisement applicable to merchandise selected by the sender.

16. A method as defined in claim 15, further comprising:
transmitting a coupon to the sender, wherein the coupon is related to the merchandise selected by the sender.

17. A method as defined in claim 1, further comprising:
transmitting to the sender an audibly discernible list of merchandise available at a source specified by the sender.

18. A method as defined in claim 17, further comprising:
receiving from the sender a merchandise selection.

19. A method as defined in claim 18, further comprising:
transmitting a coupon to the sender, wherein the coupon is applicable to merchandise selected by the sender.

20. A method as defined in claim 19, wherein the coupon comprises textual information to be received on a wireless communications device.

21. A method as defined in claim 19, wherein the coupon comprises graphical information to be received on a wireless communications device.

22. A method of obtaining information regarding merchandise, the method comprising:
transmitting a wireless communication that specifies merchandise and a source of the merchandise;
receiving on a wireless communications device information regarding specified merchandise.

23. A method as defined in claim 22, wherein the information comprises an advertisement.

24. A method as defined in claim 23, wherein the information comprises a coupon.

25. A method as defined in claim 24, wherein the information comprises a text message.

26. A method as defined in claim 22, further comprising:
receiving a prompt that facilitates identification of merchandise of interest.

27. A method as defined in claim 26, wherein the prompt comprise an audibly discernible list of shopping centers.

28. A method as defined in claim 26, wherein the prompt comprises an audibly discernible list of stores in a selected shopping center.

29. A method as defined in claim 26, wherein the prompt comprises a list of sources of merchandise.

30. A method as defined in claim 29, wherein the prompt comprise an audibly discernible identification of merchandise form the specified source.

31. An article comprising a machine-readable storage medium that comprises instructions that, if executed, enable a system to:
receive a wireless communication from a sender;
prompt the sender to specify merchandise of interest to the sender; and
transmit a wireless communication to the sender, wherein the wireless communication comprises an advertisement to the sender, wherein the advertisement is related to the merchandise of interest.

32. An article as defined in claim 31, further comprising instruction that, if executed, enable the system to:
transmit a coupon to the sender, wherein the coupon is related to the merchandise of interest.

33. An article as defined in claim 31, further comprising instruction that, if executed, enable the system to:
transmit to the sender and audibly discernible list of shopping centers; and
receive from the sender a selection of a shopping center.

34. An article as defined in claim 33, further comprising instruction that, if executed, enable the system to:
transmit to the sender an audibly discernible list of stores in a shopping center selected by the sender; and
receive a store selection from the sender.

35. An article as defined in claim 34, further comprising instruction that, if executed, enable the system to:
transmit to the sender an audibly discernible list of merchandise in a store selected by the sender; and
receive a merchandise selection from the sender.

36. A method of promoting merchandise, the method comprising:
receiving at an IVR system a communication from a sender, wherein the communication indicates merchandise of interest to he sender; and
transmitting to the sender from the IVR system information related to the merchandise of interest.

37. A method as defined in claim 36, wherein the information comprises specials applicable to the merchandise of interest at a particular source of the merchandise of interest.

38. A method as defined in claim 37, further comprising:
transmitting to the sender a coupon applicable to the merchandise of interest.

39. A method as defined in claim 36, further comprising:
prompting the sender to specify merchandise of interest to the sender.

40. A method as defined in claim 39, wherein prompting comprises:
transmitting a wireless communication to the sender, the wireless communication comprising an audibly discernable list of shopping centers; and
receiving a selection of a shopping center from the sender.

41. A method as defined in claim 40, further comprising:
transmitting to the sender an advertisement applicable to a shopping center selected by the sender.

42. A method as defined in claim 40, further comprising:
transmitting to the sender an audibly discernible list of stores in a shopping center selected by the sender; and
receiving a store selection from the sender.

43. A method as defined in claim 42, further comprising:
transmitting to the sender an advertisement applicable to a store selected by the sender.

44. A method as defined in claim 42, further comprising:
transmitting to the sender an audibly discernible list of merchandise in a store selected by the sender; and
receiving a merchandise selection from the sender.

45. A method as defined in claim 44, further comprising:
transmitting to the sender an advertisement applicable to merchandise selected by the sender.

46. A method as defined in claim 45, further comprising:
transmitting a coupon to the sender, wherein the coupon is related to the merchandise selected by the sender.

47. A method of maintaining customized advertisements, the method comprising:
accessing an ad server;
entering an advertisement on the ad server; and
receiving, in real-tune, a confirmation of the advertisement.

48. A method as defined in claim 47, wherein the ad server is accessed through the Internet.

49. A method as defined in claim 48, further comprising:
viewing a webpage that contains a plurality of windows.

50. A method as defined in claim 49, further comprising:
receiving at a window a synthesized audible rendition of an advertisement.

51. A method as defined in claim 49, further comprising:
receiving at a window a recorded voice rendition of an advertisement.

52. A method as defined in claim 49, further comprising:
receiving at a window a coupon in textual form.

53. A method as defined in claim 47, wherein the ad server is accessed via an e-mail.

54. A method as defined in claim 47, wherein the ad server is accessed via a communications network.

55. A method as defined in claim 54, wherein the ad server is accessed through use of a wireless communications device.

56. A method as defined in claim 54, further comprising:
receiving confirmation of the advertisement through use of the wireless communications device.

57. A method as defined in claim 47, further comprising:
entering in the ad server times at which the advertisement will be disseminated.

58. A method as defined in claim 57, further comprising:
entering, in advance, on the ad server a commencement date and expiration date applicable to the advertisement.

59. A method as defined in claim 57, comprising:
specifying a boundary within which advertisements will be sent to a potential customer.

60. A method as defined in claim 59, wherein the boundary is the border of a municipal entity.

61. A method as defined in claim 59, wherein the boundary is a predetermined distance from a retailer's place of business.

62. A system comprising:
a portal to transmit information to consumers and to receive information from retailers; and
an advertisement ser coupled to the portal.

63. The system as defined in claim 62, wherein the portal is operative to transmit audio messages to consumers and receive audio messages from consumers.

64. A system as defined in claim 63, wherein the portal is operative to navigate a consumer through a sequence of queries and responses to enable a user to obtain information related to merchandise of interest to the user.

65. A system as defined in claim 62, wherein the portal is operative to transmit message to and to receive messages from the retailer.

66. A system as defined in claim 65, wherein the portal is operative to receive advertisement maintenance messages from retailer and provide confirmation messages to retailers.

67. A system as defined in claim 62, wherein the advertisement server comprises:
an AD Setup function;
a Reporting function; and
an Account Setup function.

68. A system as defined in claim 67, wherein the advertisement server is accessible via the Internet.

69. A system as defined in claim 69, wherein the advertisement sever comprises a graphical user interface to enable advertisement maintenance.
